(19) United States
(12) Patent Application Publication
(10) Pub. No.: US 2026/0349001 A1
(43) Pub. Date: Nov. 5, 2026

(54) APPARATUS FOR SAMPLE HANDLING AND SYSTEM FOR SAMPLE HANDLING AND ANALYSIS

(71) Applicant: DEUTSCHES KREBSFORSCHUNGSZENTRUM STIFTUNG DES ÖFFENTLICHEN RECHTS, Heidelberg (DE)

(72) Inventors: Jeroen Krijgsveld, Heidelberg (DE); Adela-Eugenie Vrsanova, Heidelberg (DE)

(73) Assignee: DEUTSCHES KREBSFORSCHUNGSZENTRUM STIFTUNG DES ÖFFENTLICHEN RECHTS, Heidelberg (DE)

(21) Appl. No.: 18/992,487

(22) PCT Filed: Jul. 5, 2023
(86) PCT No.: PCT/EP2023/068501

§ 371 Date: Jan. 8, 2025

(30) Foreign Application Priority Data
Jul. 8, 2022 (EP) 22183801.4

(51) Int. Cl. G01N 35/10; G01N 30/72; G01N 35/08

(52) U.S. Cl. CPC G01N 35/1097; G01N 35/08; G01N 35/1004; G01N 30/7233

(57) ABSTRACT

The present disclosure provides an apparatus (200) for sample handling, comprising: a fluid control device (210) having an internal and/or external volume, the fluid control device (210) being connectable to a sample storage device (100) containing a content of a sequence of samples (S1-S4) separated by a separation medium (SM), the fluid control device (210) being further connectable to a sample analysis system (10) configured for sample analysis; a pump device (220) connected to the fluid control device (210) and configured to transport the content of the sample storage device (100) into the internal and/or external volume of the fluid control device (210); a detection device (230) at the sample storage device (100) and configured to distinguish between the samples (S1-S4) and the separation medium (SM) when the content is transported into the internal and/or external volume of the fluid control device (210); and a controller configured to operate the pump device (220) and the fluid control device (210) based on a detection signal received from the detection device (230).

### FIELD

Embodiments of the present disclosure relate to an apparatus for sample handling, a system for sample handling and analysis, a method for sample handling, and a computer-readable storage medium for executing the method. Embodiments of the present disclosure relate more particularly to the analysis of small molecules, such as biomolecules, preferably in the fields of drug discovery, genomics, epigenomics, transcriptomics, metabolomics and proteomics, such as in the emerging field of single-cell proteomics.

### BACKGROUND

Many biochemical analysis schemes require the detection and analysis of small volumes in the range of one microliter or less. Conventional systems, such as tube-based systems and microtiter plate-based systems, are often not suitable for such biochemical analysis, since small volumes of less than one microliter cannot be efficiently handled by conventional autosamplers. Moreover, interfacing of analysis systems with miniaturized systems using sample droplets deposited on glass slides is challenging since small droplets evaporate rapidly, thus preventing their collection in a sample storage device for analysis.

### SUMMARY

In light of the above, an apparatus for sample handling, a system for sample handling and analysis, a method for sample handling, and a computer-readable storage medium for executing the method are provided.

It is an object of the present disclosure to enable small volume sample handling and analysis. Another object of the present disclosure is to enable low-input biochemical analysis, such as low-input proteomics.

The objects are solved by the features of the independent claims. Preferred embodiments are defined in the dependent claims.

According to an independent aspect of the present disclosure, an apparatus for sample handling is provided. The apparatus includes a fluid control device having an internal and/or external volume (e.g., an internal (fixed) sample volume and/or an external sample loop), the fluid control device being connectable to a sample storage device containing a content of a sequence of samples separated by a separation medium, the fluid control device being further connectable to a sample analysis system configured for sample analysis; a pump device connected to the fluid control device and configured to transport the content of the sample storage device into the internal and/or external volume of the fluid control device; a detection device at the sample storage device and configured to distinguish between the samples and the separation medium when the content is transported into the internal and/or external volume of the fluid control device; and a controller configured to operate the pump device and the fluid control device based on a detection signal received from the detection device.

The term “fluid” as used throughout the present disclosure includes gases and liquids. In particular, the sample can be a fluid, such as a gas or a liquid.

Accordingly, the detection signals generated by the detection device trigger certain actions, such as starting and stopping the operation of the pump device and actuating the fluid control device to inject the sample into the sample analysis system.

According to some embodiments, which can be combined with other embodiments described herein, the controller is configured to operate the pump device when or while the detection device detects a sample of the sequence of samples to transport the sample from the sample storage device into the internal and/or external volume of the fluid control device.

Preferably, the controller is further configured to start and/or stop operation of the pump device when the detection device detects the separation medium subsequent to the sample. In other words, the pump device is (at least temporarily) stopped once the sample has been drawn into the internal and/or external volume of the fluid control device.

Preferably, the controller is further configured to operate the fluid control device and/or the sample analysis system to move the sample in the internal and/or external volume to the sample analysis system connected to the fluid control device. For example, a pump device of the sample analysis system or another suitable means can be used to draw the sample from the internal and/or external volume of the fluid control device to the sample analysis system for analysis.

According to some embodiments, which can be combined with other embodiments described herein, the apparatus includes discharging means for discharging (discarding) at least some of the content of the sample storage device, particularly the separation medium. In other words, the separation medium is not injected into the sample analysis system but directed to, for example, waste such as another (secondary) capillary/sample storage device. Even if a particular sample analysis system is not compatible with a particular separation medium, this sample analysis system and the separation medium can be used because the separation medium is discarded and not injected into the sample analysis system. This makes it possible, for example, to combine air-separated samples with an LCMS system.

Optionally, the discharging means may also be configured to dispose of a cleaning medium used to clean at least the internal and/or external volume of the fluid control device to avoid cross-contamination between samples.

The discharging means can include any mechanism suitable to discharge (discard) the separation medium and/or cleaning medium. For example, the discharging means may include at least one of a discharge port (e.g., at the fluid control device) and a discharge pump. In some embodiments, the discharge pump can be the pump device configured to transport the content of the sample storage device into the internal and/or external volume of the fluid control device, or can be another pump device.

The apparatus of the present disclosure can sequentially deliver samples directly from the sample storage device to the sample analysis system for analysis. To do so, the apparatus uses the detection device located at (e.g., attached to and/or close to and/or surrounds) the sample storage device to distinguish between the samples and the separation medium both flowing through the sample storage device due to the operation of the pump device. The detection device selectively triggers the injection of the actual samples while the separation medium is directed to waste, optionally along with excess of sample. This makes it possible to consistently inject small sample volumes in the nanoliter range, opening up new possibilities for biochemical analysis, e.g., low-input and even single-cell proteomics. For example, the embodiments of the present disclosure may allow injection and analysis of a single cell. However, the apparatus of the present disclosure may offer advantages in areas other than small sample volume injection. For example, the apparatus could be used for fast injection (e.g., not going through an autosampler).

According to some embodiments, which can be combined with other embodiments described herein, the apparatus, in particular the fluid control device, is configured to split the sample into two or more parts. The two or more parts can have the same volume or can have different volumes. In one example, the apparatus may split the sample to deliver a specified volume of sample to the analysis system. The remaining part of the sample can be sent to waste (e.g., together with the separation medium). In another example, the apparatus may split the sample to deliver parts of the sample to two or more different analysis systems connected to the fluid control device.

According to some embodiments, which can be combined with other embodiments described herein, the fluid control device is a four-way valve, the sample storage device is a capillary, and the pump device is a syringe pump. However, the present disclosure is not limited thereto, and other fluid control devices and/or sample storage devices and/or pump devices suitable to provide the functions described herein may also be used.

According to some embodiments, which can be combined with other embodiments described herein, the apparatus for sample handling is configured for use in biochemical analysis, such as proteomics, particularly low-input biochemical analysis or low-input proteomics. However, the present disclosure is not limited thereto, and the apparatus for sample handling may also be used for other applications requiring sequential and automatic sample delivery to an analysis system.

According to some embodiments, which can be combined with other embodiments described herein, the controller is configured to operate the pump device and the fluid control device to successively transport the samples of the sequence of samples from the sample storage device to the sample analysis system for analysis. In particular, the apparatus can automatically and sequentially deliver samples to the sample analysis system for analysis.

According to some embodiments, which can be combined with other embodiments described herein, during the analysis of one sample (e.g., a first sample), another sample (e.g., a second sample) may be prepared for analysis. Specifically, the second sample may be transported into the internal and/or external volume of the fluid control device during the analysis of the first sample. When the analysis of the first sample is complete, the first sample may be discarded, and the second sample may be injected into the sample analysis system. In this way, measurement times for multiple samples can be significantly reduced.

According to some embodiments, which can be combined with other embodiments described herein, the detection device is located at the sample storage device. Preferably, the detection device at least partially encloses a circumference of the sample storage device. In other words, the sample storage device may extend through the detection device to allow a reliable (e.g., contactless and/or capacitive) detection of the samples and separation medium inside the sample storage device. However, the present disclosure is not limited thereto and other locations for the detection device are possible. For example, the sample storage device could be illuminated e.g. with laser light with a detection at the back of the sample storage device and/or on a side of the sample storage device.

According to some embodiments, which can be combined with other embodiments described herein, the sequence of samples may have a number n of samples which are arranged sequentially in the sample storage device with the separation medium interposed in between. n is a real number and can be equal to or greater than 2. For example, n can be equal to or greater than 5, 10, 15 or 20.

According to some embodiments, which can be combined with other embodiments described herein, the apparatus is configured for handling sample volumes of 1 microliter or less, 900 nanoliter or less, 800 nanoliter or less, 700 nanoliter or less, 600 nanoliter or less, 500 nanoliter or less, 400 nanoliter or less, 300 nanoliter or less, 200 nanoliter or less, or 100 nanoliter or less. In a non-limiting example, the sample volume can be in the range between 20 microliter and 1 nanoliter, or between 1 microliter and 1 nanoliter. However, the present disclosure is not limited thereto, and the samples can have a volume of more than 1 microliter.

According to some embodiments, which can be combined with other embodiments described herein, the sample storage device is a tube, such as a capillary or capillary tube. In general, capillaries are tubes with very small inner diameters.

Preferably, the sample storage device, such as the capillary or capillary tube, includes (or is made of) glass, silica, fused silica, a synthetic material, an organic thermoplastic polymer (e.g., polyether ether ketone, PEEK), or a combination thereof. However, the present disclosure is not limited thereto, and the material can be any suitable inorganic, polymeric, and/or paper material.

In a preferred embodiment, the sample storage device is made of fused silica. Fused silica is beneficial because it is chemically inert and exhibits extremely low adsorption of, for example, peptides and proteins. In addition, fused silica (and also PEEK for example) allows measurements of the conductivity of the contents passing through the sample storage device, making it possible to distinguish between the samples and the separation medium.

According to some embodiments, which can be combined with other embodiments described herein, the sample storage device has an outer diameter of 1 millimeter or less, or 500 micrometers or less. Preferably, the sample storage device has an outer diameter in the range between 100 micrometers and 1 millimeter, or in the range between 100 micrometers and 500 micrometers. In a particular non-limiting embodiment, the sample storage device has an outer diameter of about 280 micrometers or about 360 micrometers. The sample storage device can have any shape, such as round, square and the like.

According to some embodiments, which can be combined with other embodiments described herein, the sample storage device has an inner diameter of 500 micrometers or less, or 300 micrometers or less. Preferably, the sample storage device has an inner diameter in the range between 10 micrometers and 500 micrometers, or in the range between 10 micrometers and 280 micrometers. In a particular non-limiting embodiment, the sample storage device has an inner diameter of about 75 micrometers.

A length of the sample storage device can be chosen at preference, for example based on the number and/or volume of samples to be accommodated in the sample storage device.

The sample storage device, such as the capillary or capillary tube, contains a sequence of multiple samples separated by the separation medium. According to some embodiments, which can be combined with other embodiments described herein, the separation medium can be liquid and/or gas. In particular, the separation medium can be any suitable liquid or gas that does not interact with the samples and/or is not miscible with the samples.

Preferably, the gas is selected from the group including (or consisting of) an inert gas, air, and a combination thereof. For example, the gas may be helium, argon, hydrogen, methane, carbon dioxide or nitrogen, or any combination thereof.

Preferably, the liquid is selected from the group including (or consisting of) water, a solvent, such as a non-polar solvent or a polar solvent, and a combination thereof. For example, the water may be demineralized or (ultra)purified water (e.g. commercially available as HPLC-grade, UPLC-grade, or MS-grade). Additionally, or alternatively, the solvent may by acetonitrile, methanol, or any combination thereof. In another example the liquid may contain (smaller) amounts of other solvents such as DMSO and/or TFA. In addition, the solvent may contain other chemicals, e.g. detergents, that have been added before sample collection to promote cell lysis.

According to some embodiments, which can be combined with other embodiments described herein, only one kind or type of separation medium is used to separate the samples inside the sample storage device. Alternatively, two or more different separation media (e.g., air and water) can be used to separate the samples inside the sample storage device.

According to some embodiments, which can be combined with other embodiments described herein, the separation medium can contain one or more markers or marker materials (e.g., one marker in various concentrations). Additionally, or alternatively, one or more of the samples of the sequence of samples includes one or more markers or marker materials (e.g., one marker in various concentrations). These markers allow to distinguish between individual samples by causing a detection signal intensity.

The term “sample” as used throughout the present disclosure refers to a material/substance/compound which (or components of which) is/are to be analyzed. The material/substance/compound may be solid, liquid, gas, a material of some intermediate characteristics such as gel or sputum, tissue, organism, or a combination of these.

Preferably, the sample is a biological material/substance/compound or biological sample. In some embodiments, the sample may be, or include, a single cell or a plurality of cells, such as human cells, or a lysate comprising cell components, such as proteins. In further embodiments, the sample may be, or include, compounds or molecules, such as small molecules and also metabolites and drugs. In an exemplary embodiment, sample preparation, such as cell lysis, compound extraction, and/or protein digestion, may be performed in the sample storage device, preferably for all samples simultaneously. The sample preparation can be performed before the sample is transported to the sample analysis system via the fluid control device. Preferably, sample preparation is performed before the sample storage device is connected to the fluid control device.

In a non-limiting embodiment, the sample that is transported to the sample analysis system via the fluid control device can be, or include, a peptide mixture arising from proteolytic digestion of proteins for proteome analysis. However, the present disclosure is not limited thereto, and the sample that is transported to the sample analysis system via the fluid control device can be, or include, intact proteins (“top-down proteomics”), metabolites (metabolomics), other biomolecules (e.g. RNA, DNA), or other molecules (e.g. drugs) or chemicals.

According to some embodiments, which can be combined with other embodiments described herein, all of the samples in the sample sequence in the sample storage device are of the same kind or type. For example, the samples may be from the same biological specimen. Alternatively, at least some samples of the sample sequence in the sample storage device may be of different kind or type. For example, the samples may be from different biological specimen. In other examples the sample(s) may also be drugs or chemicals (e.g. to check for purity of molecules, or reaction intermediates after synthesis).

According to some embodiments, which can be combined with other embodiments described herein, the fluid control device is a valve, such as a valve having m ports, in particular a four-way valve, i.e., a valve having four ports. m is a real number and can be equal to or greater than 4. For example, m can be equal to or greater than 4, 5, 6, 7, 8, 9, 10 or more for complex arrangements of connections. In addition, the valve may contain an internal (fixed) sample volume, but other configurations can use an external sample loop (e.g., positioned between two ports of the valve and/or with volumes ranging from 1-20 microliters).

Preferably, the four-way valve has a first port, a second port, a third port and a fourth port. Optionally, one or more further ports can be provided, e.g., for discharging the separation medium and/or a cleaning medium.

Preferably, the four-way valve includes a valve chamber and a plug in the valve chamber.

Preferably, the plug is cylindrical, tapered, or a ball.

Preferably, the plug has a first passage and a second passage to connect adjacent ports.

Preferably, the first passage and/or the second passage is configured to provide the internal and/or external volume in which a sample can be contained.

Preferably, the first port and the second port are connectable by the first passage and/or the second passage. Additionally, or alternatively, the third port and the fourth port are connectable by the first passage and/or the second passage.

Preferably, the sample storage device is connectable to the first port, the pump device is connected to the second port, and the sample analysis system is connectable to the third port and/or the fourth port.

According to some embodiments, which can be combined with other embodiments described herein, the four-way valve has a first flow position and a second flow position. In particular, the four-way valve may be actuated to change between the first flow position and the second flow position. In some embodiments, the actuation may be electrical, pneumatic, or manual.

Preferably, the first passage (or the second passage) connects the first port and the second port in the first flow position. Optionally, the second passage (or the first passage) connects the third port and the fourth port in the first flow position.

Additionally, or alternatively, the first passage (or the second passage) connects the third port and the fourth port in the second flow position. Optionally, the second passage (or the first passage) connects the first port and the second port in the second flow position.

According to some embodiments, which can be combined with other embodiments described herein, the controller is configured to operate the pump device to transport the sample from the sample storage device to the internal and/or external volume when the four-way valve is in the first flow position (or the second flow position). For example, the pump device can draw the sample from the sample storage device into the internal and/or external volume using negative pressure.

According to some embodiments, which can be combined with other embodiments described herein, the controller is configured to operate the four-way valve to change from the first flow position to the second flow position after the sample has been transported from the sample storage device to the internal and/or external volume, such as the first passage or the second passage.

Preferably, the sample is moved from the internal and/or external volume to the sample analysis system when the four-way valve is in the second flow position. For example, a pump device of the sample analysis system or another suitable means can be used to draw the sample from the internal and/or external volume of the fluid control device to the sample analysis system for analysis when the four-way valve is in the second flow position.

According to some embodiments, which can be combined with other embodiments described herein, the pump device is a syringe pump, such as a programmable syringe pump (e.g., with infusion/retraction). Alternatively, the pump device can be another pumping system, such as a liquid chromatography pump, which is robust and allows higher pressure, a more stable flow and a more accurate flow rate.

The detection device is configured to distinguish at least between the samples and the separation medium. Optionally, the detection device can be configured to detect one or more further media, such as a cleaning medium. In particular, the detection signals can be different for different media/materials.

Preferably, the apparatus (e.g., the controller thereof) is configured to discriminate between the samples and the separation medium (and optionally the one or more further media) based on an amplitude of the detection signal generated by the detection device. The different detection signals may be used to control the operation of sample handling and/or sample analysis. In particular, the detection signals indicate which medium/material is in the internal and/or external volume of the fluid control device and/or which medium/material is to be injected next into the internal and/or external volume of the fluid control device. Based on this, the operation of the sample handling and/or the sample analysis can be controlled.

According to some embodiments, which can be combined with other embodiments described herein, the detection device is selected from the group including (or consisting of) a conductivity sensor, an optical sensor, a contactless sensor, a thermal detector and combinations thereof.

Preferably, the detection device is a capacitively-coupled contactless conductivity detector, C4D. Alternatively, the detection device can use a thermal method such as calorimetry exploiting differences in heat capacity between the different media inside the sample storage device (e.g., air/sample/solvents).

According to some embodiments, which can be combined with other embodiments described herein, the detection device is configured to detect a liquid and/or a gas as the separation medium.

According to some embodiments, which can be combined with other embodiments described herein, the apparatus further includes cleaning means configured to inject a cleaning medium into the internal and/or external volume of the fluid control device to clean the internal and/or external volume. In some embodiments, the cleaning medium may be water or a solvent.

Preferably, the cleaning means is configured to inject or introduce the cleaning medium into the internal and/or external volume after the sample has been moved to the sample analysis system and before another sample is transported from the sample storage device into the internal and/or external volume. In some embodiments, two or more cleaning processes and/or two or more cleaning means using the same or different cleaning media can be used to consecutively clean the internal and/or external volume for even more efficient washing.

According to another independent aspect of the present disclosure, a system for sample handling and analysis is provided. The system includes the apparatus for sample handling described herein and the sample analysis system.

According to some embodiments, which can be combined with other embodiments described herein, the sample analysis system includes a liquid chromatography (LC) system and/or a mass spectrometer (MS).

Preferably, the sample analysis system is a liquid chromatography-mass spectrometry (i.e. LCMS) system. In other embodiments, LC might also be coupled to ultraviolet (UV) detection for some applications, and/or MS may be operated as standalone without LC.

According to another independent aspect of the present disclosure, a method for sample handling (and analysis) is provided. The method includes operating a fluid control device to set a first flow position, wherein the fluid control device is connected to a sample storage device containing a content of a sequence of samples separated by a separation medium; detecting, by a detection device located at the sample storage device, the content of the sample storage device; operating a pump device when the detection device detects a sample of the sequence of samples and stop operation of the pump device when the detection device detects the separation medium subsequent to the sample, to transport the sample from the sample storage device to an internal and/or external volume of the fluid control device; operating the fluid control device to set a second flow position; and moving the sample in the internal and/or external volume to a sample analysis system connected to the fluid control device.

According to some embodiments, which can be combined with other embodiments described herein, the method further includes analyzing, by the sample analysis system, the sample or at least one component of the sample.

Preferably, the analysis of the sample or at least one component (e.g., proteins) of the sample is performed using, for example liquid chromatography-mass spectrometry, LCMS, or another analysis technique.

Embodiments are also directed at apparatus and system aspects for carrying out the disclosed method and include method aspects for performing each described apparatus aspect and system aspect. These method aspects can be performed by way of hardware components, a computer programmed by appropriate software, by any combination of the two or in any other manner. Furthermore, embodiments according to the disclosure are also directed at methods of operating the described apparatus and system. The disclosure includes method aspects for carrying out every function of the apparatus and system.

According to another independent aspect of the present disclosure, a machine-readable medium is provided. The machine-readable medium includes instructions executable by one or more processors to implement the method for sample handling (and analysis) of the embodiments of the present disclosure.

The (e.g., non-transitory) machine-readable medium can include, for example, optical media such as CD-ROMs and digital video disks (DVDs), and semiconductor memory devices such as Electrically Programmable Read-Only Memory (EPROM), and Electrically Erasable Programmable Read-Only Memory (EEPROM). The machine-readable medium can be used to tangibly retain computer program instructions or code organized into one or more modules and written in any desired computer programming language. When executed by, for example, one or more processors such computer program code can implement one or more of the methods described herein.

According to another independent aspect of the present disclosure, an apparatus for sample handling is provided. The apparatus includes one or more processors; and a memory (e.g., the above machine-readable medium) coupled to the one or more processors and comprising instructions executable by the one or more processors to implement the method for sample handling of the embodiments of the present disclosure.

According to another independent aspect of the present disclosure, a system for sample handling and analysis is provided. The system includes one or more processors; and a memory (e.g., the above machine-readable medium) coupled to the one or more processors and comprising instructions executable by the one or more processors to implement the method for sample handling and analysis of the embodiments of the present disclosure.

### BRIEF DESCRIPTION OF THE DRAWINGS

So that the manner in which the above recited features of the present disclosure can be understood in detail, a more particular description of the disclosure, briefly summarized above, can be had by reference to embodiments. The accompanying drawings relate to embodiments of the disclosure and are described in the following:

FIG. 1 shows a process for sample preparation according to embodiments of the present disclosure;

FIG. 2 shows a system for sample handling and analysis according to embodiments of the present disclosure;

FIG. 3 shows a system for sample handling and analysis according to further embodiments of the present disclosure;

FIGS. 4A and 4B show a process for transporting samples to a sample analysis system according to embodiments of the present disclosure;

FIG. 5 shows a detection signal that distinguishes between samples and separation media;

FIG. 6 shows a flowchart of a method for sample handling according to embodiments of the present disclosure;

FIG. 7 shows base-peak chromatograms of four air-spaced samples that were consecutively analyzed by LCMS via automated sampling out of a single capillary;

FIG. 8 shows a conductivity trail of an injection of a 10 ng HeLa digest sample, enclosed between two air plugs;

FIG. 9 shows base-peak chromatograms of two air-spaced low-input samples that were consecutively analyzed by LCMS via automated sampling out of a single capillary;

FIG. 10 shows a conductivity trail of an injection of a 1 ng HeLa digest sample, enclosed between two air plugs;

FIG. 11 shows a base-peak chromatogram of a 10ng sample injected from a capillary through the interface and analyzed by LCMS using a Bruker timsTOF mass spectrometer; and

FIG. 12 shows extracted ion chromatograms of (A) 567.0, (B) 576.2, and (C) 714.34 m/z from a 10 ng HeLa digest sample injected in 500 nl volume through the interface in combination with a Bruker timsTOF in a 45 min gradient.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

In the following description of the invention, reference is made to proteomics and LCMS (liquid chromatography-mass spectrometry). However, the present disclosure is not limited thereto, and other fields of application and/or other analysis techniques may benefit from the sample delivery according to the invention.

Proteomics is the study of proteins and is now a key technology for clinical research. Proteins are vital components of living organisms and have many functions, such as building muscle fibers, enzymes that catalyze the digestion of food, and the synthesis and replication of DNA. Other types of proteins also include antibodies, which protect an organism from infection, and hormones, which send important signals through the body.

Many analysis techniques currently used in proteomics involve the separation of proteins (at the protein or peptide level) present in a cell or tissue prior to analysis. Liquid chromatography—mass spectrometry (LCMS), for example, combines the physical separation capabilities of high-performance liquid chromatography (HPLC) with the mass analysis capabilities of mass spectrometry (MS). LCMS is a powerful analytical tool because of the synergistic use of the individual capabilities of each technique. For example, while high-performance liquid chromatography separates cellular components such as proteins, peptides, metabolites, etc. or assemblies of molecules such as protein complexes, mass spectrometry provides spectral information to identify the individual separated components. Mass spectrometry is not only sensitive, but also enables selective detection so that complete chromatographic separation is not required.

### Sample Preparation

FIG. 1 shows a process for sample preparation according to embodiments of the present disclosure.

Sample droplets deposited on glass slides, in tubes or micro-titer plates often cannot be used in low-input biochemical analysis because small droplets evaporate rapidly and thus cannot be picked up for analysis. Evaporation can be prevented by sequentially collecting samples S1-S4 in a sample storage device 100 with a separation medium SM used to separate the samples, as it is shown in FIG. 1.

The sample storage device 100 can be a capillary which has a very small inner diameter. In some embodiments, the sample storage device 100 can be made of glass, silica, fused silica, a synthetic material, an organic thermoplastic polymer (e.g., polyether ether ketone, PEEK), or a combination thereof.

A plurality of samples are sequentially received or picked up by the sample storage device 100 to form a sequence of samples S1-S4 in the inside of the sample storage device 100. The samples S1-S4 may be arranged linearly along a longitudinal extension of the sample storage device 100 with the separation medium SM disposed therebetween.

The sequence of samples S1-S4 may consist of a number n of samples. n can be equal to or greater than 2. For example, n can be equal to or greater than 5, 10, 15, 20 or even higher.

Each sample of the sequence of samples S1-S4 can have a sample volume. The sample volume of each sample can be 1 microliter or less, 900 nanoliter or less, 800 nanoliter or less, 700 nanoliter or less, 600 nanoliter or less, 500 nanoliter or less, 400 nanoliter or less, 300 nanoliter or less, 200 nanoliter or less, or 100 nanoliter or less. In a non-limiting example, the sample volume can be in the range between 10 microliter and 1 nanoliter, or between 1 microliter and 1 nanoliter.

The separation medium SM separating adjacent samples can be liquid and/or gas. In some embodiments, the gas is an inert gas, air, or a combination thereof. For example, the inert gas may be argon or nitrogen. The liquid can be water, a solvent, or a combination thereof. For example, the water may be demineralized water. Additionally, or alternatively, the solvent may be organic solvents (e.g., acetonitril, ethanol, methanol), or mixtures thereof (or mixed with water). The liquid may contain chemicals e.g. used as buffers. However, the present disclosure is not limited thereto, and the separation medium can be any material that does not interact with the samples.

In some embodiments, only one kind or type of separation medium can be used to separate the samples inside the sample storage device. Alternatively, two or more different separation media (e.g., air and water) can be used to separate the samples inside the sample storage device. Thereby, it can be distinguished between different samples or sample patches.

Additionally, or alternatively, the separation medium and/or the samples can contain one or more (different) markers or marker materials. These markers can be detected to distinguish between individual samples or sample patches.

In some non-limiting embodiments, the samples S1-S4 are biological samples. For example, each sample may be, or include, a cell or a plurality of cells, such as human cells. In an exemplary embodiment, sample preparation, such as cell lysis and/or protein digestion, may be performed in the sample storage device, preferably for all samples simultaneously. Alternatively, sample preparation may be performed prior to sample pick-up by the sample storage device, i.e. to collect proteins that were extracted from cells, or peptides that were generated from these proteins by proteolysis.

In one example, all of the samples S1-S4 in the sample storage device 100 can be of the same kind or type. For example, all of the samples S1-S4 may be from the same biological specimen. Alternatively, at least some samples in the sample storage device may be of different kind or type. For example, the samples may be from different biological specimen.

The sample preparation shown in FIG. 1 and described above has the advantages of, for example, mechanical robustness, no evaporation, no drying-solubilization, no adsorptive peptide loss, speed, scalability, and automation capability. Furthermore, the sample storage device 100 containing the sample or sample sequence can be frozen and thawed, allowing preparation, (long) storage and later use. Additionally, or alternatively, the sample storage device 100 containing the sample or sample sequence can be sonicated and/or incubated for digestion. For example, the sample storage device 100 can be closed/capped at both ends e.g. by stoppers or septa or by other fittings, to enclose samples and separation medium, and to enhance stability and ruggedness of the sample storage device. The size of the sample storage device 100 can be scaled to the number and volume of samples and separation medium it is meant to contain.

The sample storage device 100 containing the sample sequence can be used to sequentially deliver samples directly from the sample storage device 100 for analysis, such as LCMS analysis. Accordingly, the sample storage device 100 may serve two functions, namely sample preparation (e.g., cell lysis and/or protein digestion) and sample delivery. In other words, sample preparation and sample delivery can be integrated into one single device.

### System for Sample Handling and Analysis

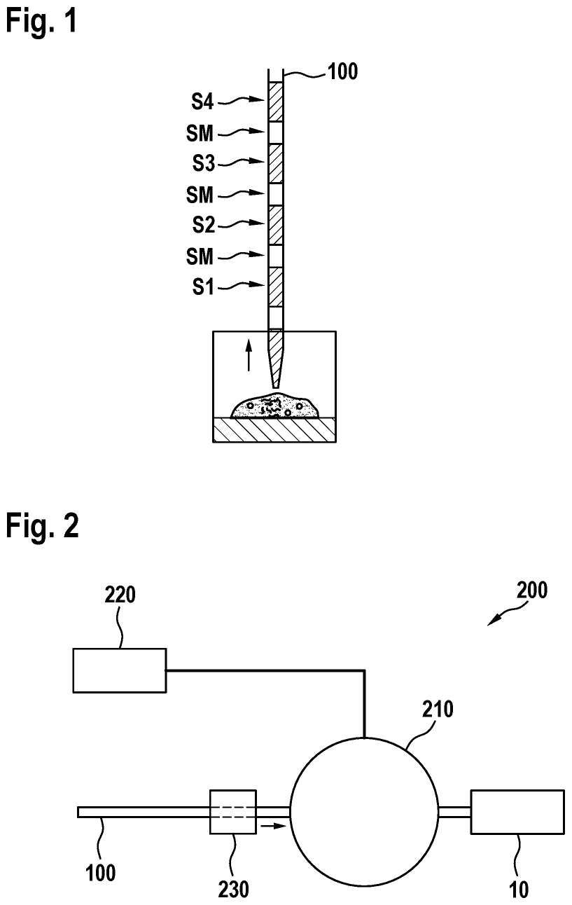

FIG. 2 shows a system 200 for sample handling and sample analysis according to embodiments of the present disclosure.

The system 200 includes a fluid control device 210 having an internal and/or external volume, the fluid control device 210 being connectable to a sample storage device 100 containing a content of a single sample or a sequence of samples, which can be separated by a separation medium. In some embodiments, the sample storage device 100 may be the sample storage device described with respect to FIG. 1. The fluid control device 210 is further connectable to a sample analysis system 10 configured for sample analysis.

The system 200 further includes a pump device 220 connected to the fluid control device 210 and configured to transport the content of the sample storage device 100 into an internal and/or external volume of the fluid control device 210, and includes a detection device 230 at the sample storage device 100 and configured to distinguish at least between the samples and the separation medium when the content is transported into the internal and/or external volume.

The system 200 further includes a controller (not shown) configured to operate the pump device 220 and the fluid control device 210 based on a detection signal received from the detection device 230.

The controller may be configured to operate the pump device 220 when the detection device 230 detects a (first) sample of the sequence of samples and stop operation of the pump device 220 when the detection device 230 detects the separation medium subsequent to the (first) sample, to transport the (first) sample from the sample storage device 100 to the internal and/or external volume of the fluid control device 210. The controller may further be configured to operate the fluid control device 210 to move the (first) sample in the internal and/or external volume to the sample analysis system 10 connected to the fluid control device 120.

At least some separation media, such as air, may not be compatible with analysis techniques such as LCMS. However, the sample handling of the present disclosure allows to directly couple the sample storage device 100 to an analysis system even if there is a separation medium which is incompatible with the analysis technique. In particular, the detection device 230 distinguishes between samples and separation media that flow through the sample storage device 100, to specifically trigger injection of actual samples while directing the separation medium (and optionally wash-solvents) to waste.

In some embodiments, the apparatus can also be configured to split the sample(s). For instance, of a 1 microliter sample, 0.5 microliter can be captured in the fluid control device and transported for sample analysis, the other 0.5 microliter (e.g., including the separation medium) can be directed to waste, being another (secondary) capillary/sample storage device. Thereby, parts of the same sample can be delivered to two or more different analysis systems and/or a defined amount of sample can be delivered to the sample analysis system(s). Additionally, or alternatively, any excess of sample beyond the capacity of the fluid control device can be directed to waste. The sample splitting capabilities can be particularly beneficial in proteome and genome/transcriptome analysis of the same single cell.

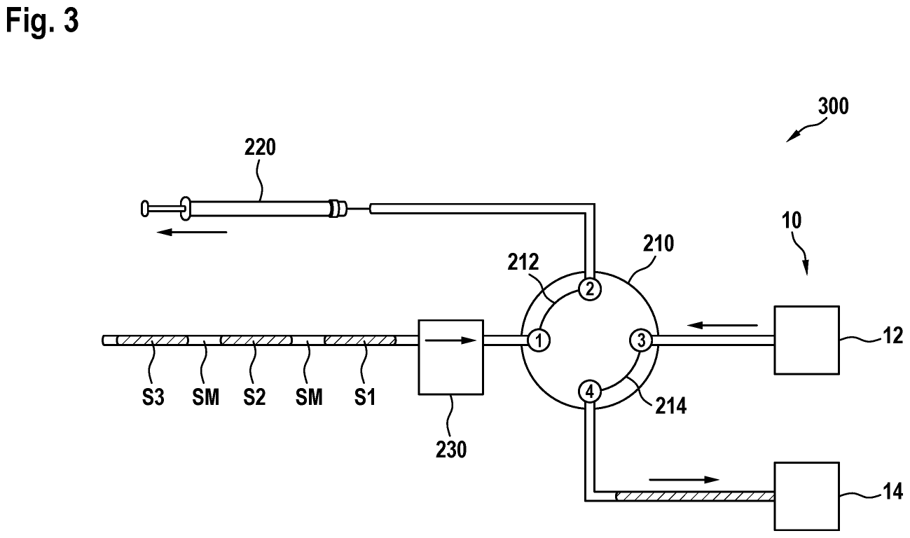

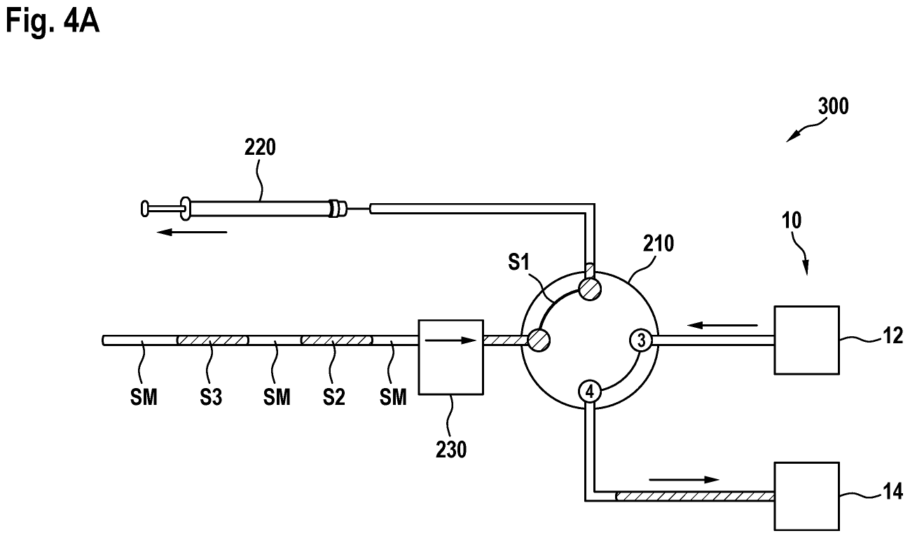

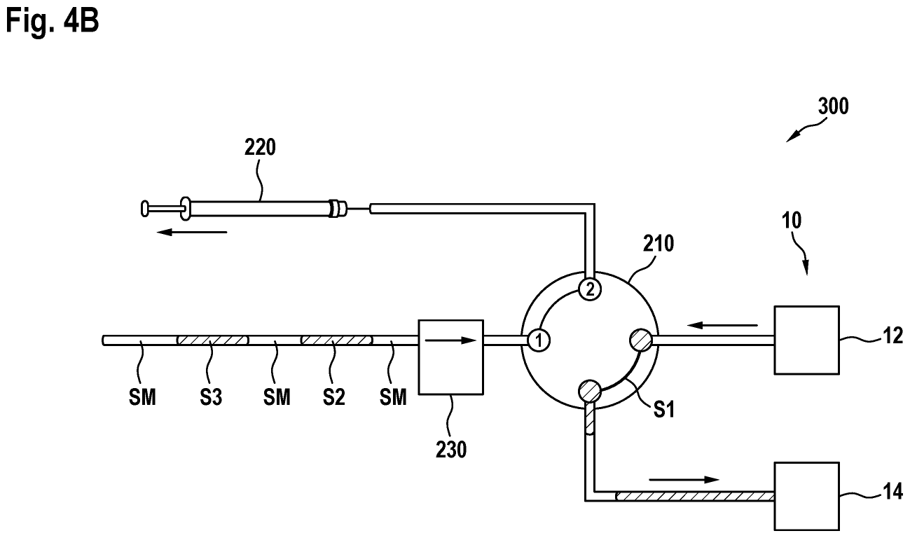

FIG. 3 shows a system 300 for sample handling and sample analysis according to further embodiments of the present disclosure. FIGS. 4A and 4B show a process for transporting multiple samples to a sample analysis system according to embodiments of the present disclosure. The system 300 of FIGS. 3, 4A and 4B is similar to the system of FIG. 2, so the following will not repeat a description of similar or identical aspects.

In the example of FIG. 3, the fluid control device 210 is a four-way valve or another valve, the sample storage device 100 is a capillary, the detection device 230 is a C4D device, and the pump device 220 is a syringe pump.

The analysis system 10 can be an LCMS system, coupling high-performance liquid chromatography 12 to mass spectrometry 14, using a chromatography column. The high-performance liquid chromatography separates components or (bio)molecules such as proteins, peptides or metabolites, and mass spectrometry provides spectral information to identify the individual separated components. Mass spectrometry is not only sensitive, but also enables selective detection so that complete chromatographic separation is not required.

The capillary contains multiple samples S1-S4 which are spaced apart from each other. In some embodiments, the samples are air-spaced samples. In a non-limiting embodiment, the sample(s) in the capillary can be, or include, a peptide mixture arising from proteolytic digestion of proteins for proteome analysis. However, the present disclosure is not limited thereto, and the samples can be, or include, intact proteins (“top-down proteomics”), metabolites (metabolomics), other biomolecules (e.g. RNA, DNA), or other molecules (e.g. drugs) or chemicals.

Preferably, the capillary 100 consists of fused silica. Fused silica is chemically inert and exhibits extremely low adsorption of peptides and proteins and allows measuring conductivity on the outside of samples that traverse through the capillary to distinguish the samples S1-S4 from the separation medium SM, such as air. Dimensions of the capillary can be flexibly chosen. For example, an outer diameter can be 360 or 280 micrometers and an inner diameter can be between 10 and 280 micrometers (e.g., 360×75 micrometers). A length of the capillary can be chosen dependent on the volume and/or number of samples that are to be analyzed.

The four-way valve 210 has two flow positions and a defined internal sample volume. In addition, the four-way valve has a first port (“1”), a second port (“2”), a third port (“3”) and a fourth port (“4”). In the example of FIG. 3, a first passage 212 is defined between the first port and the second port, and a second passage 214 is defined between the third port and the fourth port. In some embodiments, the first passage 212 and/or the second passage 214 is configured to provide the internal and/or external volume in which a sample can be received and contained. The four-way valve 210 is only one example; other valves with a suitable number of ports can also be used.

The syringe pump 220 is configured to draw samples through the capillary and the four-way valve. In particular, the capillary is connected to the first port of the four-way valve and the syringe pump is connected to the second port of the four-way valve, with the first passage 212 forming a fluid connection therebetween. The syringe pump can be actuated to draw samples from the capillary into the internal and/or external volume, such as the first passage 212. In some embodiments, the syringe pump can be a programmable syringe pump. However, the present disclosure is not limited thereto, and the pump device can be another pumping system, such as a liquid chromatography pump.

In some embodiments, the C4D device is located at the capillary, preferably enclosing a circumference of the capillary. In other words, the capillary may extend through the C4D device to allow a reliable detection of the samples S1-S4 and separation medium SM. The C4D (capacitively-coupled contactless conductivity detector) device can detect the presence of a sample in the capillary, and distinguish the sample from the separation medium, such as air or other (wash) solvents, based on differences in conductivity.

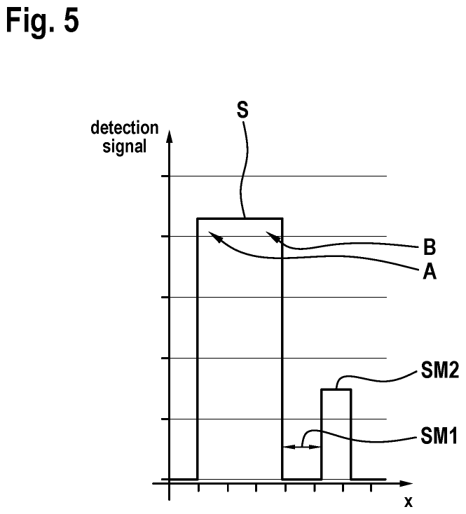

The detection signal, such as the measured conductivity, is used to trigger decisions in the system, such as starting and stopping the operation of the syringe pump and actuating the four-way valve to inject the sample into the analysis system. For example, the syringe pump is started, pulling the train of samples in the direction of the four-way valve (injection valve). Passing of a sample is detected by the C4D device due to a difference in conductivity compared to the separation medium (FIG. 5 shows a C4D signals for a sample S, air SM1, and water SM2). The flow continues until the sample is positioned in the four-way valve, which can be accurately calibrated beforehand based on the length and diameter of the connections that are used.

Once the sample is in the four-way valve, the syringe pump stops, and the four-way valve is switched to deliver the sample into the flow of the analysis system, such as a liquid chromatography system 12 to initiate the gradient for peptide separation and elution for direct analyte detection by mass spectrometry 14.

In particular, to inject the sample S1 in the first passage 212 into the analysis system 10, the four-way valve may be actuated to change from the first flow position to the second flow position when the sample S1 has arrived in the first passage 212 such that the first passage 212 and the second passage 214 change position. In other words, upon actuation, the first passage 212 with the sample S1 therein connects the third port and the fourth port which are both connected to the analysis system 10. A and B in FIG. 5 indicate a switching of the four-way valve based on the detection signal.

During the analysis of the sample (e.g., 10-60 min or shorter/longer dependent on the applied LC gradient length), the syringe pump may halt operation. Upon completion of the LCMS run, the chromatography system triggers a start signal for the syringe pump, and a switch-signal for the four-way valve. The procedure can then cycle through the above steps as long as samples last.

Optionally, samples can be interspersed with water or other solvents that can be used to wash the four-way valve, thereby preventing carryover of analytes between samples. In such a set-up, water can be directed through the four-way valve while the sample is analyzed by the analysis system. Water has a lower conductivity than sample (FIG. 5) and can thus be distinguished by C4D. This is beneficial because it allows triggering switching of the four-way valve only when the C4D-signal exceeds that of water. Since the used syringe or LC pump can be programmed, more advanced configurations are conceivable by, for example, parking a water segment in the valve for the duration of the sample analysis to allow extensive soaking or preventing the four-way valve running dry.

The above-described embodiment of the present disclosure has at least some of the following effects and advantages.

### 1. Sample Preparation

First, samples (e.g., cells) can be collected in the capillary before actual sample preparation steps, thus encapsulating the sample in a small volume throughout the process from cell lysis to injection to LCMS. This is a benefit that avoids sample loss.

Second, the use of a capillary to store and deliver samples prevents evaporation prior to sample injection. Having such a closed system is a benefit over open systems (e.g., collecting samples on a glass slide) that require humidified chambers, covering samples by oil, or drying/re-solubilization steps. In addition to being highly impractical, they are mostly only partly effective, they introduce additional challenges and contamination (oil), or may lead to sample losses (re-solubilization)

Third, sample preparation (e.g., cell lysis, protein digestion) occurs inside the capillary, and is fully compatible with heating/cooling and mechanical treatment (e.g., sonication), rendering the approach highly robust. Performing these steps for all samples simultaneously in a single capillary minimizes inter-sample variability. In addition, since this can be performed in a small volume (less than one microliter (μl)) in an enclosed, chemically inert, and non-adsorptive setting (e.g., using fused silica), this further reduces sample losses.

Fourth, in-capillary sample preparation can be seamlessly combined with FACS-sorting or CellenOne for collection of cells; cells can be spotted in small volumes with either approach, and can next be aspirated in a capillary connected to a syringe pump at the back end. Although automated systems are possible (e.g., micro-autosampler), this can even be done manually in a rapid and consistent manner (e.g., collecting dozens/hundreds of samples from a glass slide or micro-titer plate, taking few seconds per sample).

Fifth, after in-capillary sample preparation, the capillary can be stored, if required at low temperatures, long-term (weeks or even longer) until analysis.

### 2. Sample/Separation Medium Detection (C4D):

First, C4D detection is highly sensitive, and it can be used to trigger distinct decisions in the system based on the magnitude of the C4D signal. This may exceed the example to distinguish samples from air and water, but may be used to barcode samples by adding components in various concentrations to impose a C4D signal intensity. This is advantageous to connect sample origin (prior to collection in the capillary) to C4D detection and eventually MS data. As a consequence, this will allow to keep track of samples in randomized cohorts.

Second, C4D allows the combination of in-capillary sample preparation and sample delivery to the sample analysis device in one single device. More importantly, a capillary is a simple and cheap consumable, replacing expensive equipment for sample preparation (e.g., sonicator, centrifuge) and sample pick-up (e.g., autosampler).

Third, the system allows handling of very small (sub-μl) samples, contrasting with conventional autosamplers that cannot handle samples below 1 μl. The use of narrow-bore capillaries will result in extended droplet length (e.g., 20 cm/μl in a capillary with 75 μm inner diameter). Since C4D detection is triggered instantaneously at the solvent/air interface this gives ample opportunity to trigger decisions between these boundaries. This is further enabled by the capacity even of simple syringe pumps that can deliver very low flow rates (<nl/min), and by the availability of valves with internal sample chambers down to a few nl. Hence, handling a 100-nl sample will be within range, and can be decreased to below 10 nl when using a more narrow capillary (e.g., 20 μm). This sharply contrasts with conventional autosamplers that typically cannot go below 1 μl, hence requiring dilution of the sample to a larger volume even if it had initially been generated in a sub-ul droplet.

Fourth, the system is actively driven by the sample, enabled by C4D detection. This is a practical advantage, since it circumvents calculating when a sample should arrive at the valve, based on the volume of the samples and air plugs, and on the length and diameter of the used capillary, fittings, etc. All of these are prone to variability, and deviations are unavoidable especially when working with small volumes and long storage time of samples in the capillary (e.g., compression/expansion of air due to fluctuation in temperature). In fact, all of these variables become irrelevant with C4D detection, since one can detect when a sample arrives.

Fifth, the system can be scaled from a single to multiple samples for unattended operation.

Sixth, the distance from the capillary to the LC-column can be very short, since traditional autosampling and sample loops are avoided. This thus avoids sample loss.

Seventh, being able to work with very small volumes while avoiding sample dilution, evaporation/re-solubilization, and losses to other excessive sample handling, the system is particularly useful for low-input applications, ultimately for single-cell analysis.

Eighth, the system (i.e., injection valve, C4D detector and (syringe) pump) can be integrated into a single device.

### Method for Sample Handling and Analysis

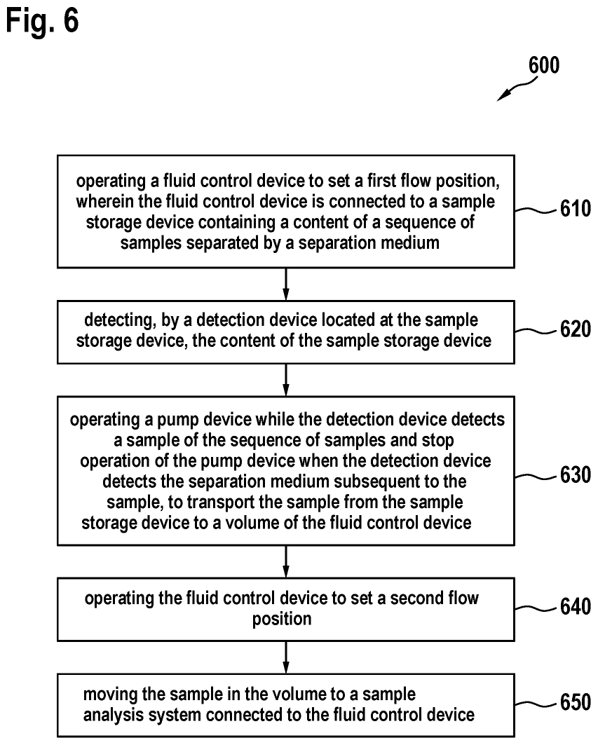

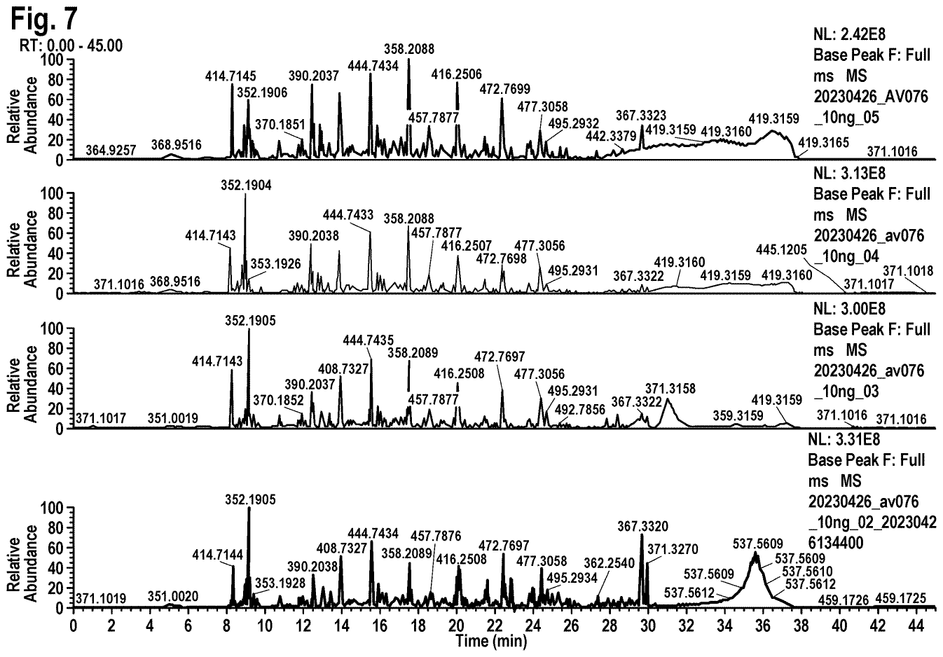

FIG. 6 shows a flowchart of a method 600 for sample handling according to embodiments of the present disclosure.

The method 600 includes in block 610 operating a fluid control device to set a first flow position, wherein the fluid control device is connected to a sample storage device containing a content of a sequence of samples separated by a separation medium; in block 620 detecting, by a detection device located at the sample storage device, the content of the sample storage device; in block 630 operating a pump device when (or while) the detection device detects a sample of the sequence of samples and stop operation of the pump device when the detection device detects the separation medium subsequent to the sample, to transport the sample from the sample storage device to an internal and/or external volume of the fluid control device; in block 640 operating the fluid control device to set a second flow position; and in block 650 moving the sample in the internal and/or external volume to a sample analysis system connected to the fluid control device.

The method 600 may further include analyzing, by the sample analysis system, the sample or at least one component of the sample, such as cells or proteins. Preferably, the sample analysis is performed using liquid chromatography-mass spectrometry, LCMS.

In some embodiments, during the analysis of the sample, another sample may be prepared for analysis. Specifically, the other sample may be transported into the internal and/or external volume of the fluid control device during the analysis of the (first) sample. When the analysis of the (first) sample is complete, the (first) sample may be discarded and the other or second sample may be injected into the sample analysis system. In this way, measurement times for multiple samples can be significantly reduced.

According to embodiments described herein, the method for sample handling (and analysis) can be conducted by means of computer programs, software, computer software products and the interrelated controllers, which can have a CPU, a memory, a user interface, and input and output means being in communication with the corresponding components of the apparatus for sample handling and/or system for sample handling and analysis.

The embodiments of the present disclosure can sequentially deliver samples directly from the sample storage device to the sample analysis system for analysis. To do so, a detection device is located at the sample storage device to distinguish between the samples and the separation medium both flowing through the sample storage device due to the operation of the pump device. The detection device selectively triggers the injection of the actual samples while the separation medium is directed to waste. This makes it possible to consistently inject small sample volumes in the nanoliter range, opening up new possibilities for biochemical analysis, e.g., low-input and even single-cell proteomics. For example, the embodiments of the present disclosure may allow injection and analysis of a single cell.

An exemplary embodiment of the system described with respect to FIGS. 3, 4A and 4B is a system for the automated and consecutive injection of air-spaced samples for proteome analysis by LC-MS. The system may include the following components: a fused silica capillary containing multiple samples separated by air; a capacitively-coupled contactless conductivity detector; an injection valve with an internal volume of 500 nl; a programmable syringe pump with a Hamilton syringe; a nano liquid chromatography pump; and a mass spectrometer with an electrospray source (e.g., timsTOF from Bruker, or QExactive HF from Thermo Fisher Scientific).

These components can be connected by a physical liquid flow that transports the sample, and by electronic signals that allow synchronous operation of these components in an integrated manner. This allows the consecutive introduction of air-spaced samples into the system for analysis by LC-MS, operating in an automated manner for multiple samples, as follows: the sample is pulled into the injection valve by the syringe at a constant flow rate. While this sample is moving in the capillary towards the valve, it passes through the conductivity detector in a contactless manner. The detector enables to distinguish sample from air by the difference in conductivity (high for samples, close to zero for air; see for instance FIG. 5). The sample is passed through the detector until the arrival of air, indicated by a sudden drop in conductivity, at the same time indicating that the sample is located in the injection valve. This triggers an electronic (e.g., analog) signal from the detector to the syringe pump to stop the flow and thus park the sample in the injection valve. In turn, the syringe pump sends an (e.g., analog) input signal to the LC pump which then triggers three events encoded in the software of the LC pump: i) switch the valve from the injection (FIG. 4A) to the running (FIG. 4B) position, ii) start the LC pump to load the sample on the LC column, and to deliver a gradient of acetonitrile in water for the separation of the peptides in the sample, and iii) start data acquisition by the mass spectrometer through a contact closure signal. During chromatography, the effluent of the LC column is sprayed into the mass spectrometer for peptide fragmentation, identification, and quantification. Upon completion of the LC gradient and data acquisition of the mass spectrometer, the LC system triggers a (e.g., analog) signal to switch back the injection valve into the injection position in order to be prepared for the next injection. The syringe pump starts to load the next sample thus initiating the next cycle of sample analysis. Collectively this establishes an automatic system that cycles through a sample loading/analysis program as long as there are samples in the capillary.

A strong asset of this implementation is that cycling through the loading/analysis program is driven by active detection of the sample. This means that operation of the system is not affected by differences in the size of samples or air plugs, or in fluctuations in liquid flow rate that may occur. For instance, an alternative scenario where the system is driven by an external timer that considers flow rate, length of tubing, and size of sample and air plugs would be highly sensitive to slight deviations in any of these parameters.

The following FIGS. 7 to 12 illustrate the superior performance of this system, performing the delivery of air-spaced samples to LCMS in an automated fashion.

FIG. 7 shows base-peak chromatograms of four air-spaced samples that were consecutively analyzed by LCMS via automated sampling out of a single capillary. Samples contained 10 ng of a HeLa digest and were delivered to the LCMS system through an injection valve (500 nl internal volume). The LCMS system consisted of an Ultimate HPLC pump and a Thermo QExactive HF mass spectrometer. Peptides were separated in a 45-min gradient. FIG. 7 shows highly reproducible chromatography, demonstrating that sampling of air-spaced samples from a capillary delivers excellent performance for proteome analysis.

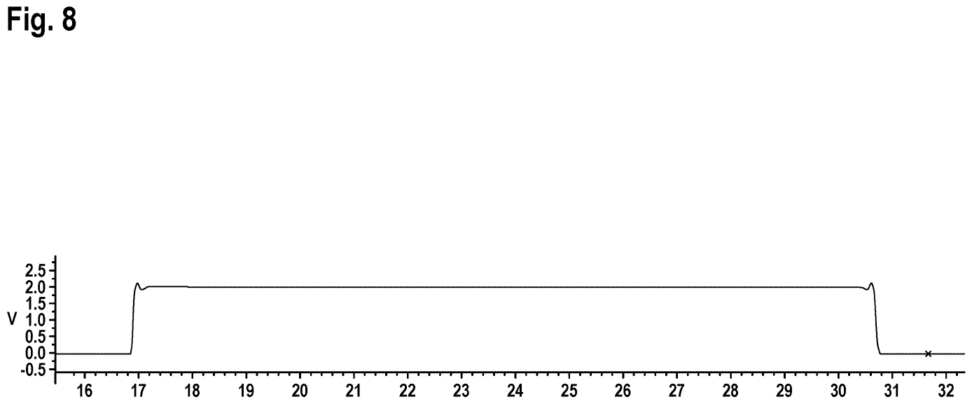

FIG. 8 shows a conductivity trail of an injection of a 10 ng HeLa digest sample, enclosed between two air plugs. Increase of the signal to from 0 to 2 Volt at t=17 s indicates detection of the sample. Decrease of the signal at t=30.7 s indicates complete transit of the sample past the detector into the injection valve. The drop in signal at t=30.7 s triggers stop of the liquid flow and switching of the valve for sample injection and analysis by LCMS.

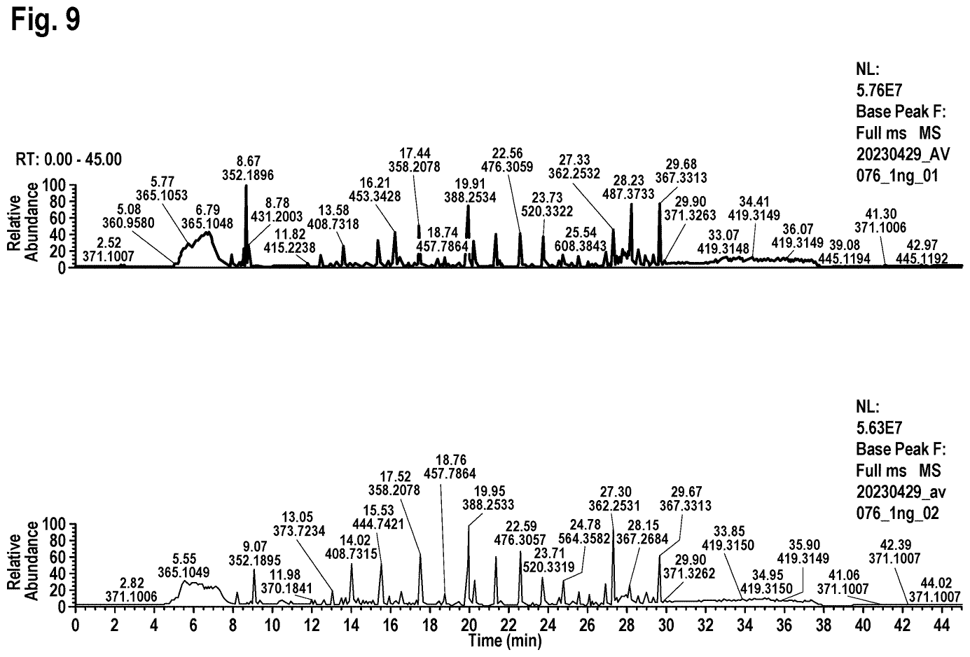

FIG. 9 shows base-peak chromatograms of two air-spaced low-input samples that were consecutively analyzed by LCMS via automated sampling out of a single capillary. Samples contained 1 ng of a HeLa digest (i.e., 10× lower than in FIG. 7), and were delivered to the LCMS system through an injection valve (500 nl internal volume). The LCMS system consisted of an Ultimate HPLC pump and a Thermo QExactive HF mass spectrometer. Peptides were separated in a 45-min gradient. FIG. 9 shows highly reproducible chromatography, demonstrating that sampling of air-spaced samples containing limited amount of material from a capillary delivers excellent performance for proteome analysis.

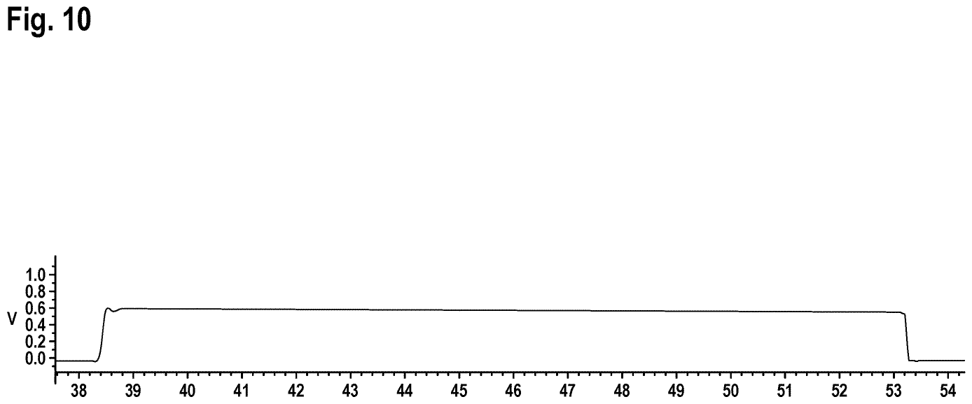

FIG. 10 shows a conductivity trail of an injection of a 1 ng HeLa digest sample, enclosed between two air plugs. Increase of the signal to from 0 to 0.6 Volt at t=38.5 s indicates detection the sample. Decrease of the signal at t=53.2 s indicates complete transit of the sample past the detector into the injection valve. The drop in signal at t=53.2 s triggers stop of the liquid flow and switching of the valve for sample injection and analysis by LCMS. FIG. 10 demonstrates stable performance of sample detection at low sample input (10× lower than in FIG. 8).

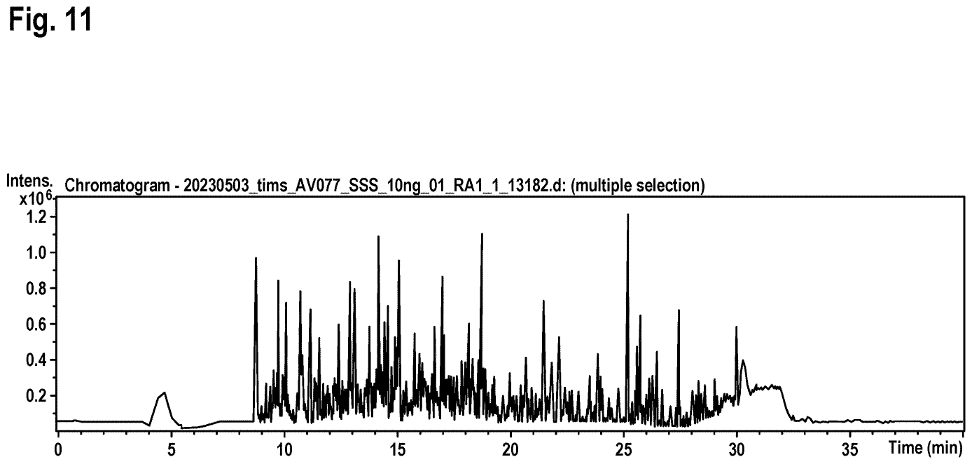

FIG. 11 shows a base-peak chromatogram of a 10 ng sample injected from a capillary through the interface and analyzed by LCMS using a Bruker timsTOF mass spectrometer. FIG. 11 demonstrates high performance using a different type of mass spectrometer compared to FIGS. 7 and 9.

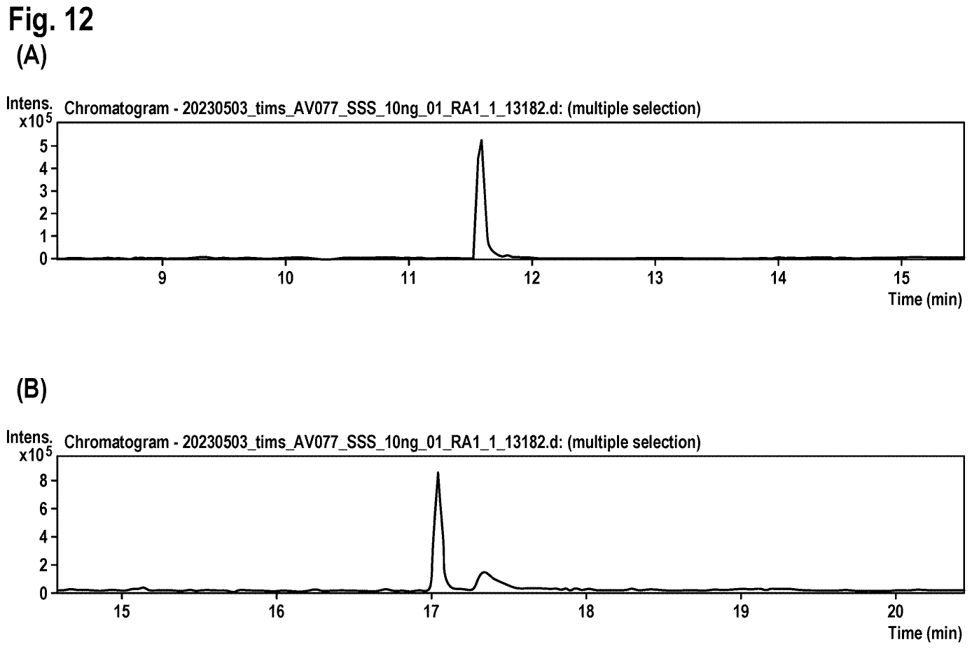

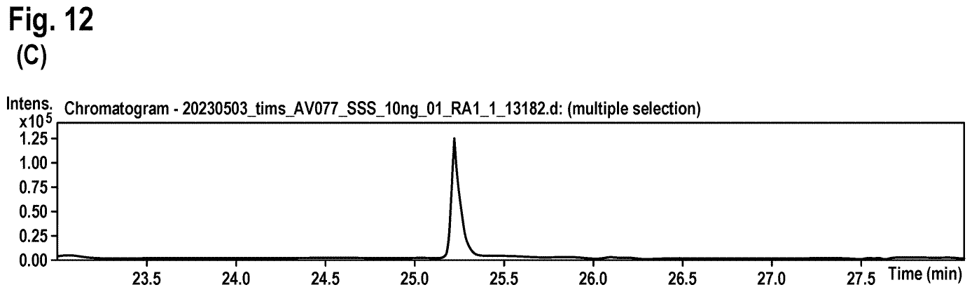

FIG. 12 shows extracted ion chromatograms of (A) 567.0, (B) 576.2, and (C) 714.34 m/z from a 10 ng HeLa digest sample injected in 500 nl volume through the interface in combination with a Bruker timsTOF in a 45 min gradient. FIG. 12 indicates a sharp peak shape (peak width at half height approximately 10 s), demonstrating excellent chromatographic performance.

In summary, dispensing a sample from the capillary provides excellent chromatography. This is advantageous because the method bypasses an autosampler with a pick-up and delivery system that is part of every setup currently in use. These autosamplers are part of a high-end and expensive technology that is not comparable to the low-cost disposables that can be used in embodiments of the present disclosure. In addition, the chromatography is highly reproducible. This is advantageous for the same reason as described above, and demonstrates that sample delivery can be very well controlled despite the simple design. Finally, not only can samples be detected that are between air plugs, but they can also be captured out of the liquid-air flow and their composition can be determined in an analytically sound and reproducible manner.

While the foregoing is directed to embodiments of the disclosure, other and further embodiments of the disclosure can be devised without departing from the basic scope thereof, and the scope thereof is determined by the claims that follow.

1-18. (canceled)

19. An apparatus for sample handling, comprising:
a fluid control device having an internal volume and/or an external volume, the fluid control device being connectable to a sample storage device containing a content of a sequence of samples separated by a separation medium, the fluid control device being further connectable to a sample analysis system configured for sample analysis;
a pump device connected to the fluid control device and configured to transport the content of the sample storage device into the internal volume and/or the external volume of the fluid control device;
a detection device at the sample storage device and configured to distinguish between the samples and the separation medium when the content is transported into the internal volume and/or the external volume of the fluid control device; and
a controller configured to operate the pump device and the fluid control device based on a detection signal received from the detection device.

20. The apparatus of claim 19, wherein the controller is configured to:
operate the pump device when the detection device detects a sample of the sequence of samples to transport the sample from the sample storage device into the internal volume and/or the external volume of the fluid control device; and
stop operation of the pump device when the detection device detects the separation medium subsequent to the sample.

21. The apparatus of claim 20, wherein the controller is configured to operate the fluid control device and/or the sample analysis system to move the sample in the internal volume and/or the external volume to the sample analysis system connected to the fluid control device.

22. The apparatus of claim 19, wherein the controller is configured to operate the pump device and the fluid control device to successively transport the samples of the sequence of samples from the sample storage device to the sample analysis system for analysis.

23. The apparatus of claim 19, wherein the apparatus is configured for handling sample volumes of 1 microliter or less.

24. The apparatus of claim 19, wherein the fluid control device is a valve having a number m of ports.

25. The apparatus of claim 24, wherein the valve is a four-way valve having a first port, a second port, a third port and a fourth port, wherein the sample storage device is connectable to the first port, the pump device is connected to the second port, and the sample analysis system is connectable to the third port and/or the fourth port.

26. The apparatus of claim 25, wherein the four-way valve has a first flow position and a second flow position, wherein the controller is configured to:
operate the pump device to transport the sample from the sample storage device to the internal volume and/or the external volume when the four-way valve is in the first flow position; and
operate the four-way valve to change from the first flow position to the second flow position after the sample has been transported from the sample storage device to the internal volume and/or the external volume, wherein the sample is moved from the internal volume and/or the external volume of the fluid control device to the sample analysis system when the four-way valve is in the second flow position.

27. The apparatus of claim 19, wherein the controller is configured to discriminate between the samples and the separation medium based on an amplitude of the detection signal generated by the detection device.

28. The apparatus of claim 27, wherein the controller is configured to discriminate between the samples, the separation medium, and one or more further media based on the amplitude of the detection signal.

29. The apparatus of claim 19, wherein the pump device is a syringe pump or a liquid chromatography pump.

30. The apparatus of claim 19, wherein the detection device is selected from the group consisting of a conductivity sensor, an optical sensor, a contactless sensor, a thermal detector and combinations thereof.

31. The apparatus of claim 19, wherein the detection device is configured to detect a liquid and/or a gas as the separation medium.

32. The apparatus of claim 19, further comprising cleaning means configured to inject a cleaning medium into the internal volume and/or the external volume of the fluid control device to clean the internal volume and/or the external volume.

33. The apparatus of claim 32, wherein the cleaning means is configured to inject the cleaning medium into the internal volume and/or the external volume after the sample has been moved to the sample analysis system and before another sample is transported from the sample storage device into the internal volume and/or the external volume.

34. The apparatus of claim 19, wherein the apparatus is configured to split the sample into two or more parts.

35. The apparatus of claim 34, wherein the two or more parts have a same volume or different volumes.

36. A system for sample handling and analysis, comprising:
a sample analysis system configured for sample analysis; and
an apparatus for sample handling, the apparatus comprising:
a fluid control device connected to the sample analysis system and having an internal volume and/or an external volume, the fluid control device being connectable to a sample storage device containing a content of a sequence of samples separated by a separation medium;
a pump device connected to the fluid control device and configured to transport the content of the sample storage device into the internal volume and/or the external volume of the fluid control device;
a detection device at the sample storage device and configured to distinguish between the samples and the separation medium when the content is transported into the internal volume and/or the external volume of the fluid control device; and
a controller configured to operate the pump device and the fluid control device based on a detection signal received from the detection device.

37. The system of claim 36, wherein the sample analysis system includes a liquid chromatography system and/or a mass spectrometer.

38. A method for sample handling, comprising:
operating a fluid control device to set a first flow position, wherein the fluid control device is connected to a sample storage device containing a content of a sequence of samples separated by a separation medium;
detecting, by a detection device located at the sample storage device, the content of the sample storage device;
operating a pump device when the detection device detects a sample of the sequence of samples and stop operation of the pump device when the detection device detects the separation medium subsequent to the sample, to transport the sample from the sample storage device to an internal volume and/or an external volume of the fluid control device;
operating the fluid control device to set a second flow position; and
moving the sample in the internal volume and/or the external volume to a sample analysis system connected to the fluid control device.
